(19) United States
(12) Patent Application Publication
(10) Pub. No.: US 2010/0285917 A1
(43) Pub. Date: Nov. 11, 2010

(54) DIFFERENTIAL GEAR

(75) Inventor: Manfred Rahm, Eisbach-Rein (AT)

Correspondence Address: HARNESS, DICKEY & PIERCE, P.L.C., P.O. BOX 828, BLOOMFIELD HILLS, MI, 48303, US

(73) Assignee: Magna Powertrain AG & Co. KG, Lannach (AT)

(21) Appl. No.: 12/518,367

(22) PCT Filed: Oct. 29, 2007
(86) PCT No.: PCT/EP07/09374

§ 371 Date: Nov. 18, 2009

(30) Foreign Application Priority Data
Dec. 13, 2006 (DE) 10 2006 058 835.5

(51) Int. Cl. F16H 48/20

(52) U.S. Cl. 475/220

(57) ABSTRACT

A transmission has a rotatable differential cage (74) and two output shafts (64). In order to distribute a torque between the output shafts (64), at least one balancing wheel (76) is rotatably mounted on the differential cage (74), which balancing wheel (76) is drive-coupled to a respective drive wheel (78) of the output shafts (64). The gearing also has at least one concavely curved coupling wheel (80) which is drive-coupled firstly to at least one of the drive wheels (78) and secondly to at least one hollow shaft (82). The hollow shaft (82) surrounds one of the output shafts (64). The hollow shaft (82) can be braked or driven relative to a part of the gearing.

### CROSS-REFERENCE TO RELATED APPLICATIONS

This application is a 371 U.S. National Stage of International Application No. PCT/EP2007/009374. filed Oct. 29, 2007. This application claims the benefit of German Patent Application No. DE 10 2006 058 835.5, filed Dec. 13, 2006. The disclosures of the above applications are incorporated herein by reference.

### FIELD

The present invention relates to a transmission for a motor vehicle having a rotatable differential cage and two output shafts, wherein at least one balancing gear which is drive-operatively coupled to a respective driven gear of the output shafts is rotatably journaled at the differential cage for the distribution of a torque between the output shafts.

### BACKGROUND

This section provides background information related to the present disclosure which is not necessarily prior art.

So-called “active yaw” systems or “torque vectoring” (TV) systems are known for modern powertrains (e.g. all-wheel powertrains). The yaw speed of the vehicle is actively controlled by a TV system, with the driving torques being able to be distributed to the wheels asymmetrically. More torque can thereby be directed, for example, to the wheel at the outside of the corner so that an oversteer behavior can be set under normal driving conditions.

To be able to suppress the generally desired balance of speed differences in specific driving situations, differential gears are also known with a selectively activatable differential lock.

Conventional differential gears include a differential which balances the speed differences of the output shafts. A pure differential cannot actively influence existing speed differences The differential gear in particular requires a plurality of additional components to transmit an increased driving torque to a specific wheel of the vehicle or to enable a differential locking operation.

### SUMMARY

It is an object of the invention to provide a transmission which can be used in a TV system and/or in a differential locking operation with a simple and compact structure.

This object is satisfied by a transmission having a rotatable differential cage, two output shafts each having a driven gear, and at least one balancing gear drive-operatively couple to the driven gears and rotatably journaled at the differential cage. The transmission furthermore has at least one concavely arched coupling gear which is drive-operatively coupled, on the one hand, to at least one of the driven gears of the output shafts and, on the other hand, to at least one hollow shaft gear, with the hollow shaft gear surrounding one of the output shafts and with the hollow shaft gear being able to be braked and/or driven relative to a part of the transmission.

The concavely arched coupling gear enables a rotationally operative coupling of one of the driven gears or of both driven gears of the output shafts to the respective hollow shaft gear, with a braking device or a drive device by means of which the hollow shaft gear can, for example, be braked or accelerated with respect to a housing of the transmission or with respect to the associated output shaft or of the differential cage being associated with the respective hollow shaft gear. A specific speed ratio can hereby be set between the output shafts. Particularly favorable transmission ratios can be realized in this respect by the concavely arched shape of the coupling gear.

The concavely arched coupling gear in conjunction with the balancing gear thus forms a compact superimposition unit which easily has room within the construction space of a given differential unit. In addition, the differential unit only requires a few parts to provide a TV operation or a differential locking operation. The differential unit is thus smaller, lighter, simpler and above all cheaper than conventional differential units which enable a TV operation or a differential locking operation. Further advantages are low rotating masses and a more favorable power flow.

It is not absolutely necessary for the named drive-operative coupling of the coupling gear to the driven gears of the output shafts that a coupling gear toothed arrangement is directly in engagement with a respective toothed arrangement of the driven gears. Instead, it is possible that the coupling gear is rotationally fixedly connected to the at least one balancing gear or to a connection gear which in turn meshes with the driven gears of the output shafts or that the coupling gear is rotationally fixedly connected to an idler gear which is in turn coupled to the driven gears of the output shafts via a balancing gear. A direct engagement is preferably provided between the coupling gear and the at least one hollow shaft.

In a preferred embodiment, the transmission furthermore includes a second balancing gear which is drive-operatively coupled to the driven gears of the output shafts and a second concavely arched coupling gear which is drive-operatively coupled, on the one hand, to the second balancing gear and, on the other hand, to the at least one hollow shaft gear. The transmitting torque is thus distributed between a plurality of coupling gears as well as a plurality of balancing gear, whereby the gears, toothed arrangements and bearings can be made smaller and whereby symmetrical, balanced forces are adopted at the hollow shaft gear or hollow shaft gears.

In a further preferred embodiment, the coupling gear or coupling gears are rotatably journaled at the differential cage. The balancing gear thus acts as a conventional differential balancing gear which drives the output shafts upon rotation of the differential unit. No additional balancing gears are required in this manner.

In a further preferred embodiment, the number of teeth of a toothed arrangement of the coupling gear or of the plurality of coupling gears is larger than the number of teeth of an associated toothed arrangement of the respective hollow shaft gear. In a similar manner, the number of teeth of a toothed arrangement of the balancing gear or of the plurality of balancing gears is preferably smaller than the number of teeth of an associated toothed arrangement of the respective driven gear of the output shafts. Advantageous transmission ratios are thereby achieved, with a transmission of the superimposition unit of less than 15% being achievable.

In a further preferred embodiment, the coupling gear is rotationally fixedly connected to an idler gear via an intermediate shaft, with the idler gear meshing with at least one balancing gear which in turn meshes with the driven gears. The transmission ratios of less than 15%, for example, can thus be achieved because the idler gear can be very small.

In accordance with a further advantageous embodiment, the mutually meshing toothed arrangements of coupling gear and hollow shaft gear and/or the mutually meshing toothed arrangements of balancing gears, optionally idler gears and driven gears are not made—as usual—as bevel gear toothed arrangements, but rather as crown gear pairs. This permits an even more compact construction, extended transmission ranges and the elimination of axial forces. Crown gear pairs are characterized in that a crown gear meshes with a spur gear. In such a construction, the hollow shaft toothed arrangement is, for example, made as a spur gearing and the coupling gear, for example, as a crown gear. Alternatively or additionally, the balancing gears and/or idler gears are made as spur gears and the driven gears as crown gears.

A powertrain of a motor vehicle includes a transmission in accordance with the invention. The transmission can be made for the torque transfer along a longitudinal axis of the powertrain. Alternatively or additionally, such a transmission can be made for the torque transfer along one or more transverse axes of the powertrain.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of the selected embodiments and not all possible implementations have been described such that the drawings are not intended to limit the scope of the present disclosure.

FIG. 1 is a schematic representation of a motor vehicle powertrain equipped with a transmission in accordance with the invention;

FIG. 2a is a sectional representation of a first embodiment of a transmission with a TV operation;

FIG. 2b is a sectional side representation along a central symmetry plane of a differential unit associated with the transmission in accordance with FIG. 2a containing the axis B;

FIG. 2c is a sectional side representation corresponding to the representation in accordance with FIG. 2b of an alternative embodiment of the differential unit;

FIG. 3a is a sectional representation of a second embodiment of a transmission with a TV operation;

FIG. 3b is a sectional representation of the embodiment in accordance with FIG. 3a configured for use in a front axle TV operation;

FIG. 4 is a sectional representation of a first embodiment of a differential unit applicable for use with a transmission of the present disclosure;

FIG. 5 is a sectional representation of a second embodiment of a differential unit applicable for use with a transmission of the present disclosure;

FIG. 6 is a sectional representation of a third embodiment of a differential unit applicable for use with a transmission of the present disclosure;

FIG. 7 is a sectional side representation of a fourth embodiment of a differential unit applicable for use with a transmission of the present disclosure;

FIG. 8 is a sectional representation of a third embodiment of a transmission having a differential locking operation;

FIG. 9 is a sectional representation of an alternative example of the transmission embodiment in accordance with FIG. 8;

FIG. 10 is a sectional representation of a fourth embodiment of a transmission with a differential locking operation and a TV operation;

FIG. 11a is a sectional representation of a simplified embodiment of the transmission in accordance with FIG. 10 which is switched into TV operation;

FIG. 11b is a sectional representation of the transmission in accordance with FIG. 11a which is switched into the differential locking operation; and

FIG. 12 is a sectional representation of a fifth embodiment of a transmission with electric motors or electric generators.

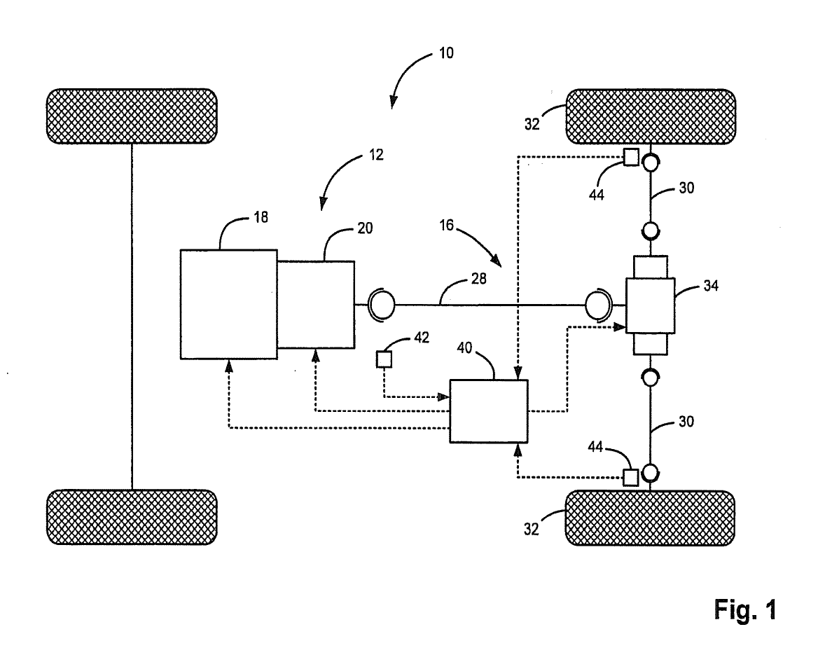

In FIG. 1, a schematic representation of an exemplary vehicle powertrain 10 is shown which includes a drive 12 which includes a power transmission path 16, a motor 18 and a shift transmission 20. The power transmission path 16 includes a Cardan shaft 28 which is driven by the shift transmission 20, a pair of half-shafts 30 connected to a pair of wheels 32, and a transmission, hereinafter referred to as an axle drive 34, which is operative to transmit a driving torque from the Cardan shaft 28 to one or both half-shafts 30. Although a vehicle powertrain with rear wheel drive is shown by way of example here, the invention can naturally also be used in a vehicle powertrain with front wheel drive or with all-wheel drive.

A control unit 40 controls the operation of the axle drive 34 on the basis of a plurality of vehicle parameters to enable a so-called “torque vectoring” (TV) operation and/or a differential locking operation. The control unit 40 is electronically connected to at least one sensor—preferably to a plurality of sensors. Example sensors include a yaw rate sensor 42, wheel speed sensors 44 and/or a steering angle sensor (not shown). Other sensors include lateral acceleration sensors and longitudinal acceleration sensors (not shown). The sensors detect a plurality of operating states, e.g. the yaw rate of the vehicle and the speed of each wheel 32. The control unit 40 processes the signal or the signals and generates an axle drive control signal, with at least one actuator being controlled on the basis of the axle drive control signal to actively influence the transfer of the driving torque to the wheels 32.

Although the axle drive 34 in accordance with FIG. 1 is integrated into a rear axle of the vehicle powertrain 10, the axle drive can be made not only for the torque transfer along a transverse axis, but also for the torque transfer along a longitudinal axis. The transmission 34 or an additional transmission can, for example, be integrated into the shift transmission 20 or into a four-wheel drive transfer case.

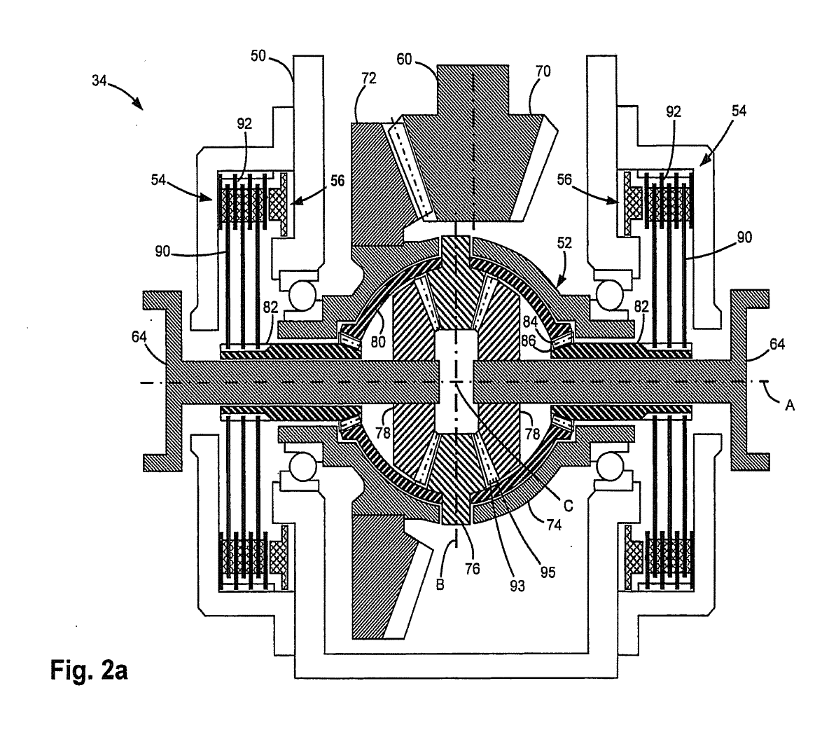

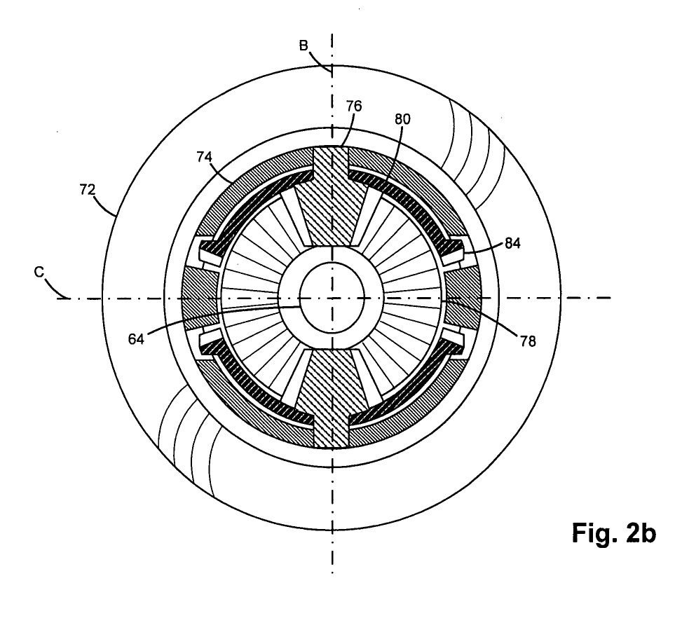

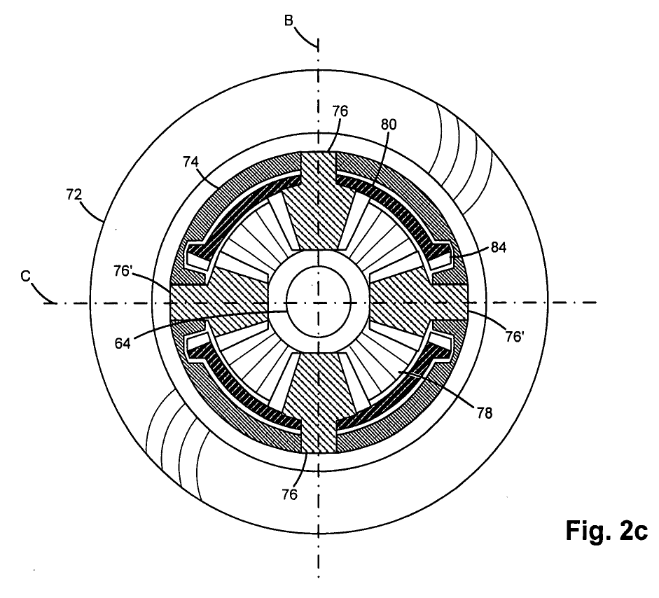

The components of the axle drive 34 in accordance with a first embodiment will now be described with reference to FIGS. 2a and 2b. The axle drive 34 includes a transmission housing 50, a differential unit 52 as well as brakes 54 with corresponding actuators 56. A drive shaft 60 which is rotationally fixedly connected to the Cardan shaft 28 (FIG. 1), for example, is rotatably journaled in the transmission housing 50. A drive bevel gear 70 formed at an end of the drive shaft 60 is in meshed engagement with a crown gear 72. The crown gear 72 is rotationally fixedly connected to the differential unit 52 so that a rotary movement of the Cardan shaft 28 effects a rotary movement of the differential unit 52. Output shafts 64 which are rotationally fixedly connected to the half-shafts 30 (FIG. 1) are rotatably journaled in the differential unit 52 which is in turn rotatably journaled in the transmission housing 50. The output shafts 64 rotate about an axis A.

The differential unit 52 includes a differential cage 74 and a gearset including balancing gears 76 made as bevel gears and driven gears 78. The balancing gears 76 are driven by the rotating differential cage 74 to make an orbital movement about the axis A and are in this respect rotatably journaled in the differential cage 74 about an axis B which extends in an orthogonal direction with respect to the axis A. The balancing gears 76 mesh with the driven gears 78 which are rotationally fixedly connected to the respective output shafts 64. In the differential unit 52, the drive takes place via the differential cage 74 and the mutually oppositely disposed balancing gears 76 to the driven gears 78. When driving straight ahead in normal operation, the balancing gears 76 and the driven gears 78 do not rotate relative to one another. The total differential unit 52 circulates as a block and transmits the torque uniformly to the two output shafts 64. Only on speed differences (e.g. on cornering or asymmetrical slip ratios) between the two output shafts 64 do the two balancing gears 76 rotate oppositely in the differential cage 74 to distribute the torque generally uniformly to the two output shafts 64.

The gearset of the differential unit 52 furthermore includes concavely arched—or also bell-shaped—coupling gears 80 and hollow shaft gears 82. Each of the coupling gears 80 is rotationally fixedly connected to a respective balancing gear 76 and rotates with it about the axis B. The coupling gears 80 are thus also drivable by the differential cage 74 to make a respective orbiting movement about the axis A. The coupling gears 80 are arranged within the differential cage 74. Each of the hollow shaft gears 82 surrounds a respective output shaft 64, with the hollow shaft gears 82 being rotatably journaled inside the differential cage 74. The coupling gears 80 are rotationally operatively connected to the hollow shaft gears 82, with each coupling gear 80 engaging over the respective balancing gear 76 and engaging behind the respective driven gear 78, i.e. with respect to the axis A each coupling gear 80 engages over the respective driven gear 78 in the axial direction and is simultaneously shaped radially inwardly. Each of the coupling gears 80 includes a toothed arrangement 84 which meshes with corresponding toothed arrangements 86 of the hollow shafts 82. A transmission ratio i₁ is thus formed between each of the coupling gears 80 and the respective hollow shaft gear 82. In a similar manner, a transmission ratio i₂ is formed between each of the balancing gears 76 and the driven gears 78.

The number of teeth of the toothed arrangement 84 of the coupling gear 80 is preferably larger than the number of teeth of the associated toothed arrangement 86 of the hollow shaft gear 82. In addition, the number of teeth of a toothed arrangement 95 of the respective driven gear 78 of the output shafts 64 is preferably larger than the number of teeth of an associated toothed arrangement 93 of the balancing gear 76. Advantageous transmission ratios i₁, i₂ are thus achieved to achieve a total ratio of, for example, less than 15% for the torque transmission explained in the following.

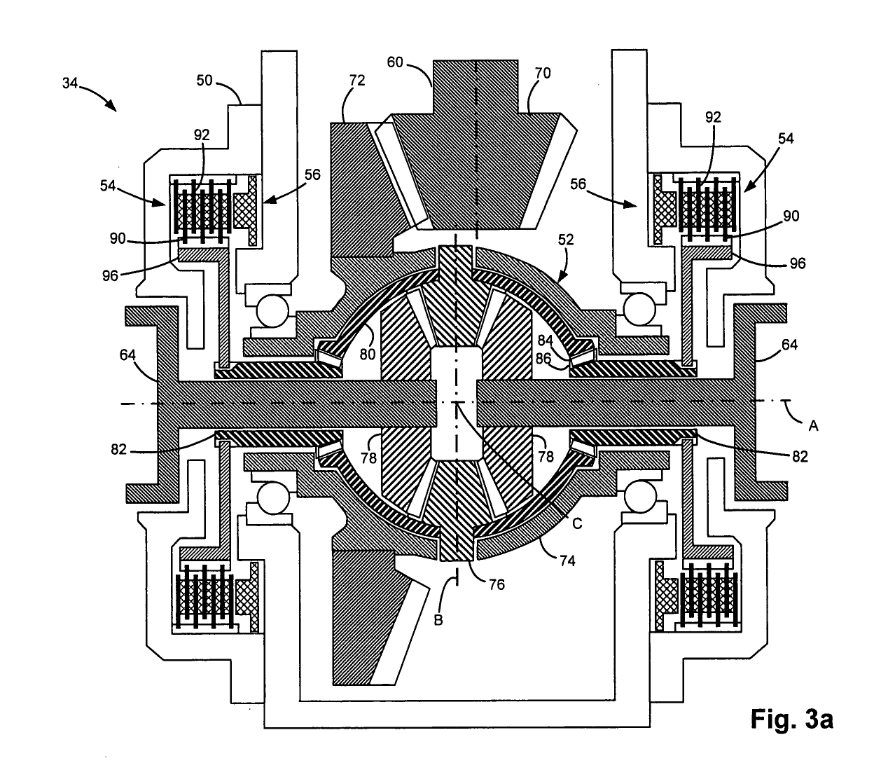

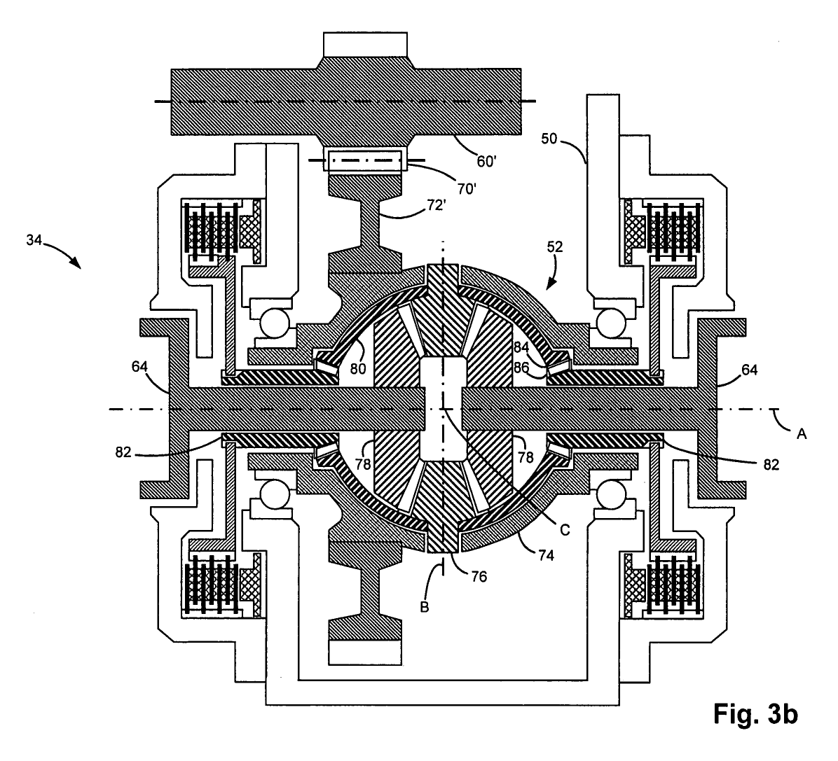

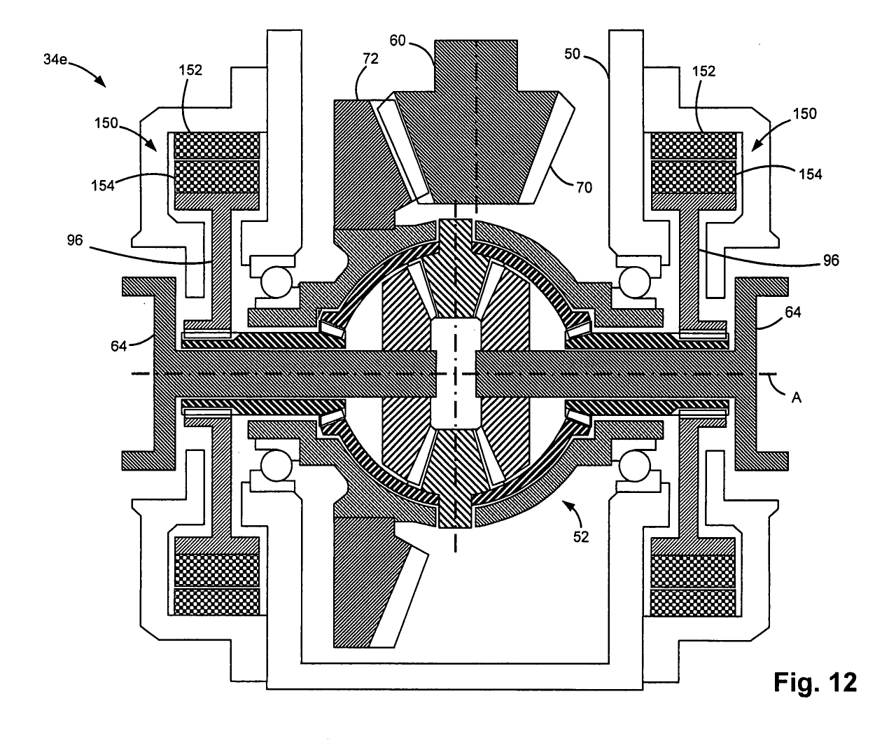

Each of the brakes 54 includes a first disk set 90 as well as a second disk set 92. The disks of the first disk set 90 are rotationally fixedly connected to the respective hollow shaft gear 82 and the disks of the second disk set 92 are rotationally fixedly connected to the transmission housing 50, with the disks of the disk sets 90, 92 engageable with one another. The disks of the disk sets 90, 92 can be pressed toward one another for the transmission of a torque such that a braking force is transmitted between the disks of the disk sets 90, 92 which acts to brake disks of the first disk set 90 as well as the respective hollow shaft gear 82. Although the brakes 54 shown in FIG. 2a (and also in FIG. 3a) are made as multidisk clutches, any brake arrangements or drive arrangements can naturally be used, in particular also electric motors for the driving and/or for the generator braking, cf. FIG. 12. In connection with the invention, wet or dry running multidisk clutches, disk brakes and disk clutches, magnetorheological clutches or electromagnetically actuated clutches are suitable as brake arrangements.

It must still be noted with respect to the embodiment in accordance with FIGS. 2a and 2b that the drive of the differential unit 52 does not generally absolutely have to take place via a driven bevel gear. In the case of use as a front axle TV unit, for example, the drive can also take place via spur gears or via a chain. An application is also provided in which the differential unit 52 is not actively driven at all. The differential unit 52 in particular also works as a torque displacement apparatus on a non-driven axle. In this case, one wheel of the vehicle receives a negative torque and the other wheel a corresponding positive torque without superimposed driving torque.

Although two coupling gears 80 with corresponding balancing gears 76 are shown in the embodiment in accordance with FIGS. 2a and 2b, the differential unit 52 can also include more or fewer coupling gears 80. The differential unit 52 can, for example, include only one single coupling gear 80 with a corresponding balancing gear 76. Alternatively to this, the differential unit 52 can, for example, include three coupling gears 80 with corresponding balancing gears 76.

As shown in FIG. 2c, the differential unit 52 can include one or more additional balancing gears 76′ which are rotatably journaled in the differential cage 74 and which are not in meshed engagement with the coupling gears 80. Such additional balancing gears 76′ are only in engagement with the driven gears 78 and rotate about an axis C which is perpendicular to the axis A and transverse—i.e. perpendicular or oblique—to the axis B. The vertical balancing gears 76 in FIG. 2 thus primarily serve for the TV operation (or differential locking operation) whereas the horizontal balancing gears 76′ in FIG. 2c only serve for the axle drive.

In the embodiment of FIG. 3a, unlike the embodiment in accordance with FIG. 2a, a hub 96 is provided which is rotationally fixedly connected to the respective hollow shaft gear 82 as well as to the disks of the first disk set 90. By the use of the hub 96, the ends of the output shafts 64 can be offset further inwardly. The construction space for the axle drive 34 can thus be minimized in the transverse direction. The half-shafts 30 can furthermore be correspondingly longer, with the deflection angles of the half-shafts occurring on deflection being minimized.

In the embodiment in accordance with FIG. 3b, the rotationally operative connection between the drive shaft 60′ and the differential unit 52 is made as a spur gear connection. In this respect, a spur gear 70′ of the drive shaft 60′ engages a spur gear 72′ which is rotationally fixedly connected to the differential unit 52. This embodiment is suitable for a TV application in which the drive does not take place via an angle drive (e.g. rear axle), but rather via a spur drive (e.g. front axle TV or front axle differential lock with a transverse engine arrangement). The drive thereby takes place directly at the “final drive” of the shift transmission 20, for example. Alternatively to this, a chain is possible as a drive element.

In the following, the function of the axle drive 34 in accordance with FIGS. 2, 3a and FIG. 3b will be explained.

A torque transmission ratio is set between the output shafts 64 by the braking of one of the hollow shaft gears 82 by means of the associated brake 54—or also by driving the respective hollow shaft gear 82 (e.g. by means of an electrical motor, cf. FIG. 12). If one of the hollow shaft gears 82 is braked with respect to the transmission housing 50, the coupling gears 80, which are driven by the rotating differential cage 74 to make an orbital movement about the axis A are namely driven to a rotation movement about the respective axis B. Accordingly, the balancing gears 76 are also driven about the axis B, with the balancing gears 76 accelerating one of the output shafts 64 and braking the other of the output shafts 64. For example, the left hand output shaft 64 in the representation in accordance with FIG. 2a, FIG. 3a or FIG. 3b is accelerated and the right hand output shaft 64 is braked when the right hand hollow shaft gear 82 is braked with respect to the housing 50.

A superimposed speed nₛ on the basis of the following equation results in the event that the hollow shaft gear 82 is fully braked with respect to the housing 50:

nₛ=n_{AXIS}·i₁·i₂

where n_{AXIS} is the speed of the differential cage 74 about the axis A. In the event that the right hand hollow shaft 82 is fully braked, the respective speeds n_{R}, n_{L} of the right hand and left hand output shafts 64 are calculated on the basis of the following equations:

n_{R}=n_{AXIS}−nₛ

n_{L}=n_{AXIS}+nₛ

In the event that the left hand hollow shaft 64 is fully braked, the respective speeds n_{R}, n_{L} of the right hand and left hand output shafts 64 are calculated on the basis of the following equations:

n_{R}=n_{AXIS}+nₛ

n_{L}=n_{AXIS}−nₛ

In the event that the respective brake 54 is not complete, but is operated with slip, a reduced superimposed speed nₛ results and thus speeds n_{R}, n_{L} are closer to the axle speed n_{AXIS}.

The use of the concavely arched coupling gears 80 allows a small, light, simple and above all cheap differential unit 52 with a TV operation and/or a differential locking operation, which will still be explained in more detail in the following. The concavely arched coupling gear 80 in particular forms a small-volume superimposition unit in connection with the balancing gear 76 which easily has room within the construction space of the differential unit 52. In addition, the differential unit 52 requires substantially fewer parts to provide a TV operation. The differential unit 52 is thus smaller, lighter, simpler and above all cheaper than conventional differential units which provide a TV operation.

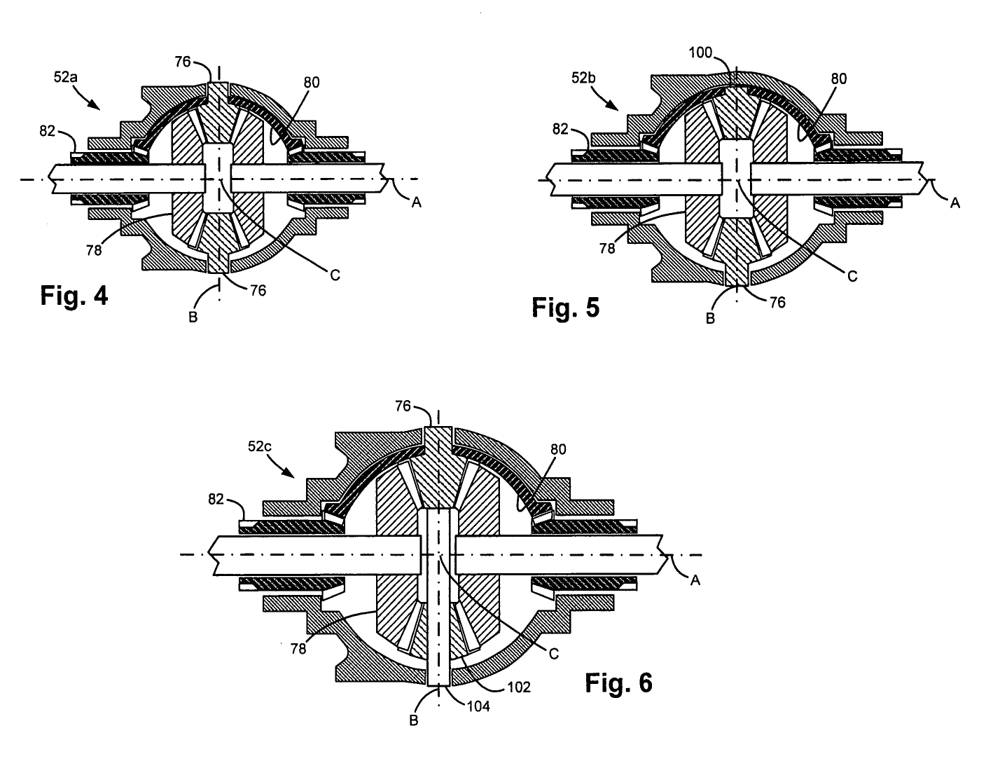

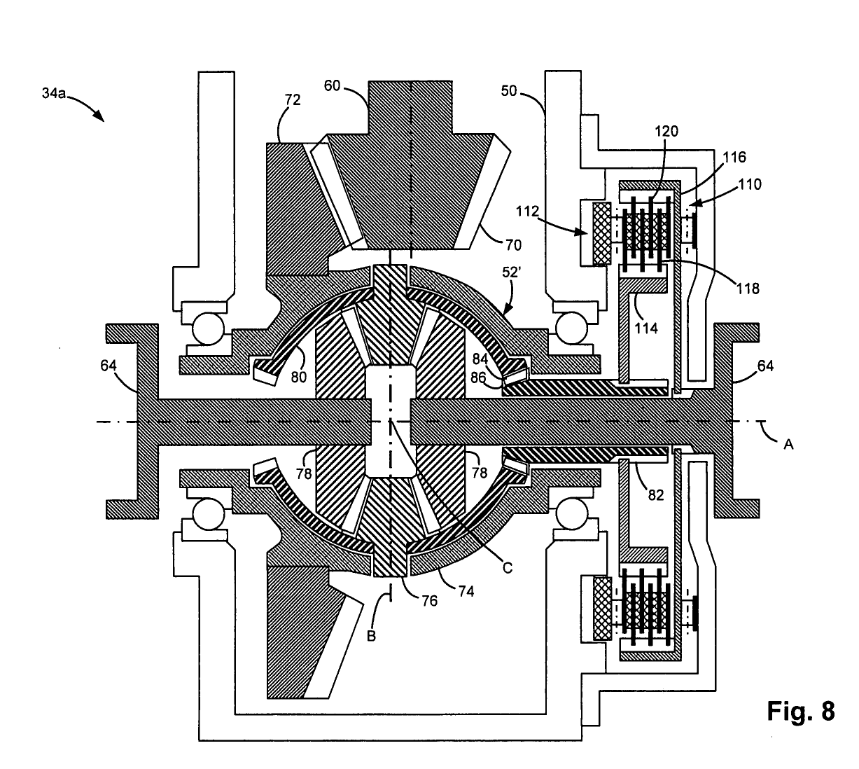

Different embodiments of the differential unit 52 will now be explained in more detail with reference to FIGS. 4-6, with the further components of the respective transmission being able to be made as described above in connection with FIGS. 2a and 3a for the axle drive 34 or as will still be explained in the following in connection with FIGS. 8 to 12.

The differential unit 52a of FIG. 4 includes two balancing gears 76 and only one concavely arched coupling gear 80 which is rotationally fixedly connected to one of the balancing gears 76, with the balancing gears 76 and the coupling gear 80 rotating about the axis B.

The differential unit 52b of FIG. 5 includes a balancing gear 76, a connection gear 100 and a concavely arched coupling gear 80. The balancing gear 76 is also driven here by the rotating differential cage 74 to make an orbital movement about the axis A. The connection gear 100 is in engagement with the driven gears 78 of the output shafts 64 and is rotationally fixedly connected to the coupling gear 80. The connection gear 100 is, however, not rotatably journaled at the differential cage 74, i.e. the connection gear 100 is not driven directly by the differential cage 74 to make an orbital movement about the axis A, but rather it only provides the application of a differential torque to the driven gears 78 by means of the coupling gear 80. The connection gear 100 and the coupling gear 80 can also be made in one piece, which generally applies to all the variants described here.

The differential unit 52c of FIG. 6 includes a balancing gear 76, a coupling gear 80 as well as an additional balancing gear 102. The balancing gear 76 is driven by the differential cage 74 to make an orbital movement about the axis A and it meshes with the driven gears 78. A web 104 extends from the balancing gears 76 along the axis B and is rotationally fixedly connected to the balancing gear 76 and is rotationally journaled on the oppositely disposed side in the differential cage 74. The additional balancing gear 102 is rotatably journaled about the web 104 and is likewise in engagement with the driven gears 78.

Each of the embodiments in accordance with FIGS. 4-6 can have an additional balancing gear or balancing gears which are in engagement with the driven gears 78 and rotate about the axis C which is perpendicular to the axis A and transverse—i.e. perpendicular or oblique—to the axis B.

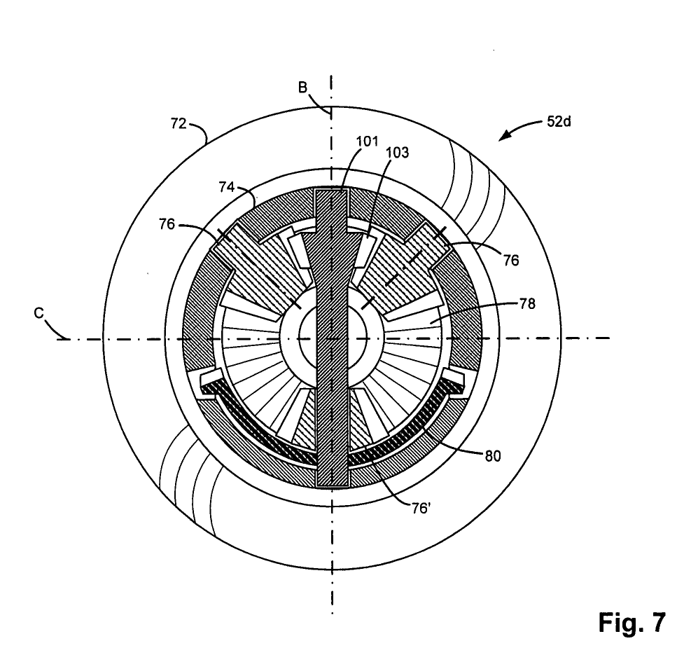

FIG. 7 shows a further embodiment of the differential unit 52d. In this embodiment, the coupling gear 80 is rotationally fixedly connected via an intermediate shaft 101 which is rotatably journaled in the differential cage 74 to an idler gear 103 which is arranged at the inner side of the differential cage 74 at the oppositely disposed side of the differential cage. This idler gear 103 does not mesh directly with the driven gears 78, but rather with at least one balancing gear 76 which in turn meshes with the driven gears 78. A third balancing gear 76′ is here rotatably journaled on the intermediate shaft 101, but can also be omitted. A particular advantage of this embodiment lies in the fact that transmission ratios smaller than 15%, for example, can be presented because the idler gear 103 can be very small.

A further embodiment of an axle drive 34a in accordance with the invention which enables a differential locking operation will be explained in more detail with reference to FIG. 8.

The axle drive 34a includes only one single hollow shaft gear 82 as well as a multidisk clutch 110 with a corresponding actuator 112. The multidisk clutch 110 selectively enables a rotationally fixed connection between the hollow shaft gear 82 and one of the output shafts 64 to effect a differential locking operation. The multidisk clutch 110 in particular has a clutch hub 114 which is rotationally fixedly connected to the hollow shaft 8 gear 2 and a clutch cage 116 which is rotationally fixedly connected to the respective output shaft 64. The disks of a first disk set 118 are rotationally fixedly connected to the clutch hub 114 and the disks of a second disk set 120 are rotationally fixedly connected to the clutch cage 120, with the disks of the disk sets 118, 120 engageable with one another. The disks of the disk sets 118, 120 can be pressed toward one another for the transmission of a torque such that a torque is transmitted between the disks of the disk sets 118, 120 to rotationally fixedly connect the clutch hub 114 and the clutch cage 116 or to set a braking torque against a relative rotation of the clutch hub 114 and the clutch cage 120. Generally, no complete braking is required. The differential unit 52′ is locked on the connection of the hollow shaft gear 82 to the output shaft 64; i.e. on a complete braking, the total differential unit 52′ circulates as a block and always transmits the driving torque transmitted by the drive shaft 60 uniformly to the two output shafts 64. The transmission ratios i₁ and i₂ enable a coupling torque or reactive torque which is smaller than the locking torque. The locking torque is the torque countering the relative movement between the output shafts 64 in the differential unit 52′. A clutch torque thus hereby results in contrast to the usual transverse lock in which the clutch torque has to amount to up to twice the locking torque which amounts, for example, approximately to the factor 0.3 of the locking torque. A much smaller multidisk clutch 110 is thus therefore required to achieve the locking effect. One of the two coupling gears 80 can selectively also be omitted here.

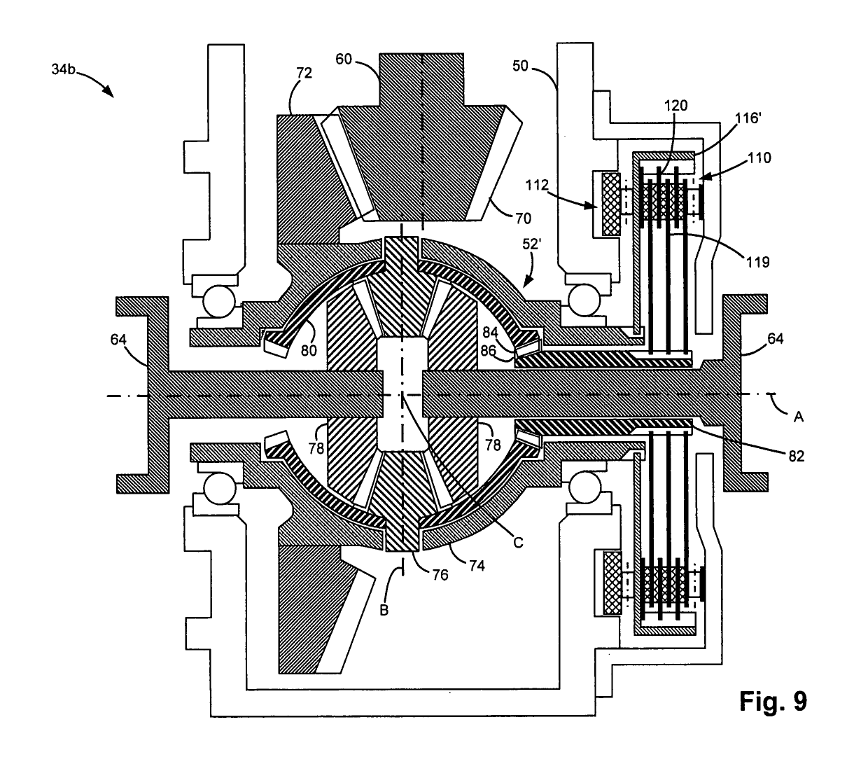

FIG. 9 shows an alternative example of the embodiment in accordance with FIG. 8. The clutch cage 116′ is in particular rotationally fixedly connected to the differential cage 74. When the disks 119, 120 are pressed on, the hollow shaft 82 and the differential cage 74 are rotationally fixedly connected or a braking torque is set against a relative rotation of the hollow shaft 82 and the differential cage 74. This produces a very small demand on the clutch torque, for example only 150 Nm, to achieve 1000 Nm locking torque, for example. It is generally also not necessary to brake completely in this embodiment.

Alternatively to the representation of the axle drive 34b in accordance with FIG. 9, two multidisk clutches 110 can be arranged in symmetrical arrangement at both sides of the differential unit 52′. These clutches 110 would then only have to be designed for a braking torque of, for example, 75 Nm in each case with respect to the aforesaid example.

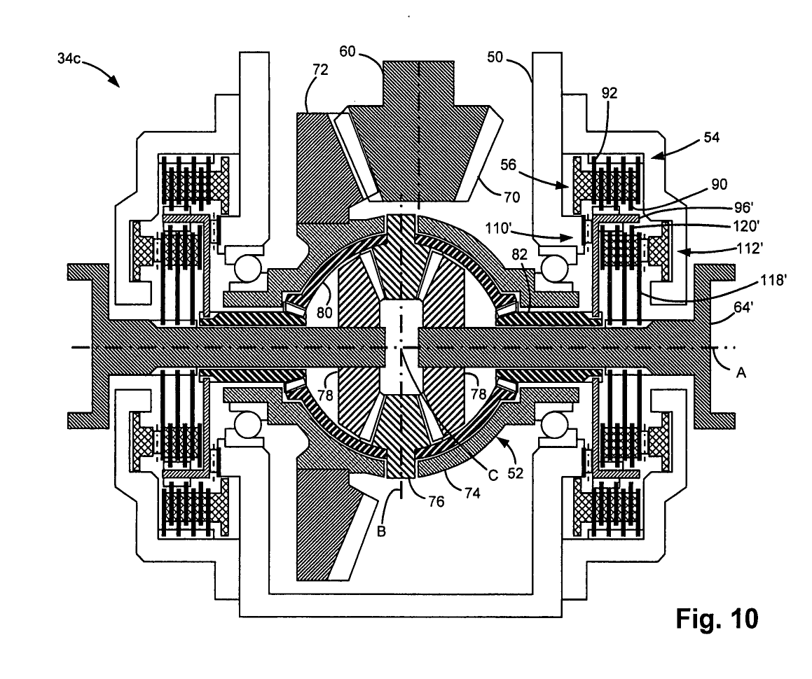

A further embodiment of an axle drive 34c in accordance with the invention will be explained in more detail with reference to FIG. 10. The axle drive 34c is made similar to the axle drive 34 in accordance with FIG. 3a and additionally includes a multidisk clutch 110′ for a differential locking operation. The multidisk clutch 54 in particular enables a TV operation and the multidisk clutch 110′ a differential locking operation. The hub 96′ of the multidisk clutch 54 simultaneously forms a clutch cage of the multidisk clutch 110′. The disks of a first disk set 118′ of the multidisk clutch 110′ are rotationally fixedly connected to the output shaft 64′ and the disks of a second disk set 120′ are rotationally fixedly connected to the hub 96′, with the disks of the disk sets 118′, 120′ engageable with one another. The disks of the disk sets 118′, 120′ can be pressed toward one another for the transmission of a torque such that a torque is transmitted between the disks of the disk sets 118′, 120′ to brake the hollow shaft gear 82 and the output shaft 64′ with respect to one another or to connect them rotationally fixedly. Selectively, one of the two multidisk clutches 110′ for the locking operation can be omitted, i.e. only one single multidisk clutch 110′ is absolutely required.

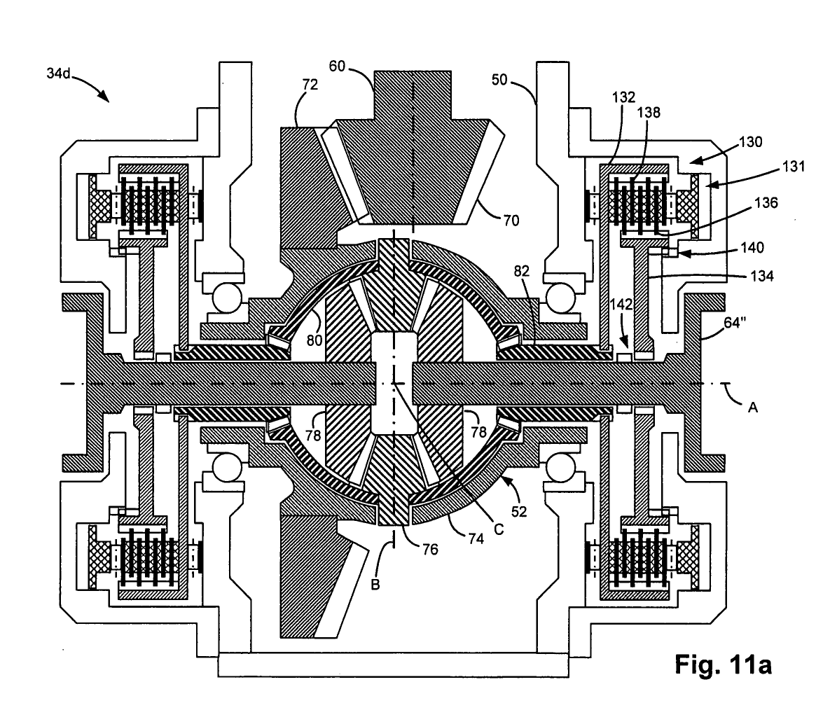

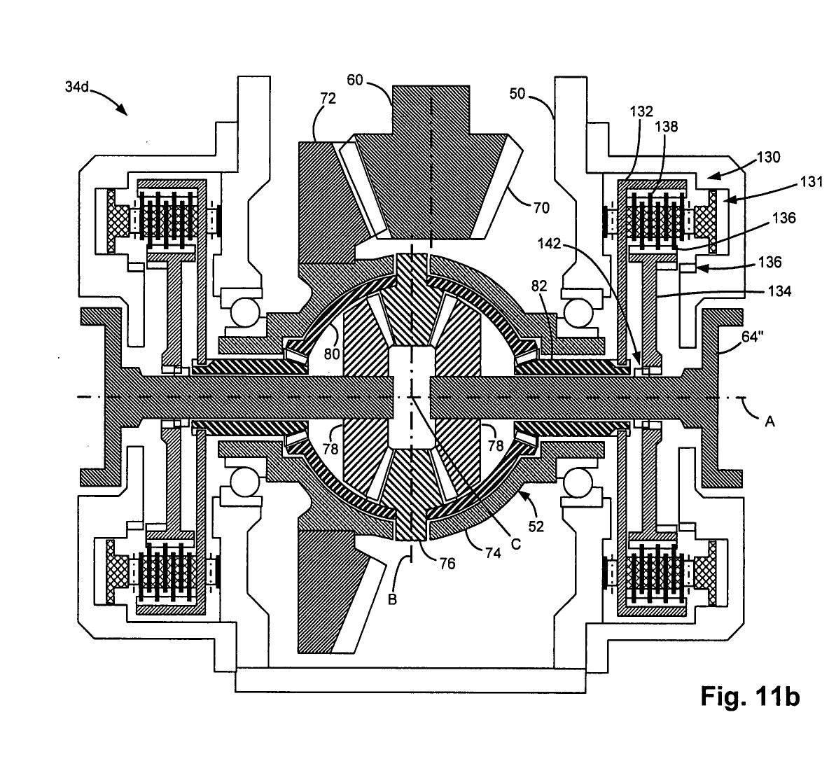

Yet a further embodiment of an axle drive 34d in accordance with the invention will be explained in more detail with reference to FIGS. 11a and 11b. The axle drive 34d is made similar to the axle drive 34 in accordance with FIG. 2, but includes an alternative clutch arrangement 130 with a corresponding actuator 131. The clutch arrangement 130 has a clutch cage 132, a switchable clutch hub 134 as well as first and second disk sets 136, 138. The disks of the first disk set 136 are rotationally fixedly connected to the clutch hub 134. The disks of the second disk set 138 are rotationally fixedly connected to the clutch cage 132.

The clutch cage 132 is rotationally fixedly connected to the hollow shaft gear 82. The clutch hub 134 is switchable between a first and a second position. In the first position shown in FIG. 11a, the clutch hub 134 is rotationally fixedly connected to the transmission housing 50 via toothed arrangements 140 to enable the TV operation. In particular, upon actuation of the multidisk clutch 130, the hollow shaft gear 82 is braked with respect to the transmission housing 50 to drive the coupling gear 80 about the axis B and thus to carry out the TV operation. In the second position shown in FIG. 11b, the clutch hub 134 is rotationally fixedly connected to the output shaft 64″ via toothed arrangements 142 to enable the differential locking operation. In particular, upon actuation of the multidisk clutch 130, the hollow shaft gear 82 is rotationally fixedly connected to the output shaft 64″ to carry out the differential locking operation. The axle drive 34d of FIGS. 11a and 11b only requires one multidisk clutch 130 and one actuator 131 per respective side to provide a TV operation and a differential locking operation. The axle drive 34c is thus smaller, lighter, simpler and cheaper.

A further embodiment of an axle drive 34e is shown in FIG. 12. The axle drive 34e in accordance with FIG. 12 includes the same components as the axle drive 34 in accordance with FIG. 2a, but the brakes 54 are omitted. Instead, the axle drive 34e includes electric motors 150, with each of the electric motors 150 having a stator 152 and a rotor 154. The stator 152 is fixedly connected to the housing 50 and the rotor 154 is rotationally fixedly connected to the hub 96 or to the hollow shaft 82. The electric motors 150 can each be operated as a motor—that is driving—or as a generator—that is braking. The introduction of positive and negative superimposed torques is thereby possible for a TV operation. The two electric motors 150 can be synchronized for a locking operation.

Deviating from the representation in accordance with FIG. 12, the electric motors 150 can also be provided with transmission gears (e.g. planetary gears) which step down the respective engine speed. High-speed engines 150 can thereby be used.

### REFERENCE NUMERAL LIST

10 vehicle powertrain
12 drive
16 power transmission path
18 motor
20 transmission
28 Cardan shaft
30 half-shaft
32 wheel
34, 34a, 34b axle drive
34c, 34d, 34e
40 control unit
42 yaw rate sensor
44 wheel speed sensor
50 differential housing
52, 521 52a, differential unit
52b, 52c, 52d
54 brake
56 actuator
60, 601′ drive shaft
64, 64′, 64″ output shaft
70 drive bevel gear
70′ driven gears
72 crown gear
72′ spur gear
74 differential cage
76, 76′ balancing gear
78 driven gear
80 coupling gear
82 hollow shaft gear
84, 86 toothed arrangement
90, 92 disk set
93, 95 toothed arrangement
96, 961 hub
100 connection gear
101 intermediate shaft
102 additional balancing gear
103 idler gear
104 web
110, 110′ multidisk clutch
112, 112′ actuator
114 clutch hub
116 clutch cage
118, 118′, 119 disk set
120, 120′ disk set
130 multidisk clutch
131 actuator
132 clutch cage
134 clutch hub
136, 138 disk set
140, 142 toothed arrangement
150 electric motor/generator
152 stator
154 rotor

1. A transmission comprising a rotatable differential cage, two output shafts each driving a corresponding one of two driven gears, a balancing gear which is drive-operatively coupled to the driven gears and rotatably journaled at the differential cage, a hollow shaft surrounding one of the output shafts, and a coupling gear which is drive-operatively coupled, on the one hand, to at least one of the driven gears and, on the other hand, to the hollow shaft and with the hollow shaft being able to be braked and/or driven relative to a part of the transmission.

2. The transmission in accordance with claim 1, wherein the balancing gear and the coupling gear are made in one part.

3. The transmission in accordance with claim 1, wherein the balancing gear and the coupling gear are made in two parts, with the balancing gear and the coupling gear being rotationally fixedly connected to one another.

4. The transmission in accordance with claim 1, further including a second balancing gear which is drive-operatively coupled to the driven gears of the output shafts and a second coupling gear which is drive-operatively coupled, on the one hand, to the second balancing gear and, on the other hand, to the hollow shaft.

5. The transmission in accordance with claim 1, further including a second hollow shaft which surrounds the other of the output shafts and which is drive-operatively coupled to the coupling gear, with one of the hollow shafts being selectively braked or driven to set the torque transmission ratio between the output shafts.

6. The transmission in accordance with claim 1, further including a brake, a clutch or an electric motor or electric generator for the braking or driving of the hollow shaft.

7. The transmission in accordance with claim, wherein the coupling gear is driven by the differential cage to make an orbital movement about a rotational axis of the output shafts.

8. The transmission in accordance with claim 1, wherein the coupling gear is rotatable about an axis which extends in a transverse direction with respect to a rotational axis of the output shafts.

9. The transmission in accordance with claim 1, wherein the coupling gear is drive operatively connected to the driven gears of the output shafts via the balancing gear or a connection gear.

10. The transmission in accordance with claim 1, wherein the coupling gear engages the hollow shaft behind the driven gears within the differential cage.

11. The transmission in accordance with claim 1, wherein the coupling gear is arranged within the differential cage.

12. The transmission in accordance with claim 1, wherein a portion of the hollow shaft is arranged within the differential cage.

13. The transmission in accordance with claim 1, further including a transmission housing with respect to which the hollow shaft can be braked or driven.

14. The transmission in accordance with claim 1, wherein the hollow shaft can be braked or driven relative to the associated output shaft or relative to the differential cage.

15. The transmission (34) in accordance with claim 1, wherein a toothed arrangement of the coupling gear meshes with a toothed arrangement of the hollow shaft.

16. The transmission in accordance with claim 15, wherein the toothed arrangement of the hollow shaft is arranged within the differential cage.

17. The transmission in accordance with claim 15, wherein the number of teeth of the toothed arrangement of the coupling gear is larger than the number of teeth of the associated toothed arrangement of the hollow shaft.

18. (canceled)

19. The transmission in accordance with claim 1, wherein the coupling gear is rotationally fixedly connected to an idler gear via an intermediate shaft, with the idler gear meshing with the balancing gear which in turn meshes with the driven gears.

20-22. (canceled)

23. A transmission, comprising:
an input shaft;
first and second output shafts;
a differential unit having a differential cage rotatably supported in a housing and driven by said input shaft, and a gearset disposed within said differential cage, said gearset including a first driven gear fixed for rotation with said first output shaft, a second driven gear fixed for rotation with said second output shaft, a first balancing gear meshed with said first and second driven gears, a first coupling gear fixed for rotation with said balancing gear, and a first transfer gear meshed with said first coupling gear and configured to surround said first output shaft; and
a coupling unit for selectively limiting rotation of said first transfer gear relative to one of said housing, said first output shaft and said differential cage.

24. The transmission of claim 23 wherein said coupling unit is a brake that can be selectively actuated by a control system for inhibiting rotation of said first transfer gear relative to said housing.

25. The transmission of claim 23 wherein said coupling unit is a brake that can be selectively actuated by a control system for limiting relative rotation between said first transfer gear and one of said first output shaft and said differential cage.

26. The transmission of claim 23 wherein said coupling unit is a drive motor that can be selectively actuated by a control system for varying the rotational speed of said first transfer gear.

27. The transmission of claim 23 wherein said gearset further includes a second balancing gear meshed with said first and second driven gears, and a second transfer gear surrounding said second output shaft and meshed with said first coupling gear, and wherein said transmission further includes a second coupling unit for selectively limiting rotation of said second transfer gear relative to one of said housing, said second output shaft and said differential cage.

28. The transmission of claim 27 wherein said gearset further includes a second coupling gear fixed for rotation with said second balancing gear and meshed with both of said first and second transfer gears.

29. The transmission of claim 28 wherein said first and second balancing gears are rotatably supported by said differential cage.

30. The transmission of claim 28 wherein each of said first and second coupling gears is disposed between said differential cage and corresponding ones of said first and second balancing gears and is configured to generally surround said first and second driven gears, and wherein each of said first and second coupling gears has gear teeth formed at its edge that are meshed with gear teeth formed on each of said first and second transfer gears.

31. The transmission of claim 27 wherein said first and second balancing gears are rotatably supported by said differential cage.

32. The transmission of claim 27 wherein only said second balancing gear is rotatably supported by said differential cage.

33. The transmission of claim 23 wherein said first coupling gear is disposed between said differential cage and said first balancing gear and is configured to generally surround a first portion of said first and second driven gears, and wherein said first coupling gear has gear teeth formed at its edge that mesh with gear teeth on said first transfer gear.

34. The transmission of claim 33 wherein said gearset further includes a second balancing gear meshed with said first and second driven gears, and a second coupling gear fixed for rotation with said second balancing gear, wherein said second coupling gear is disposed between said differential cage and said second balancing gear and is configured to generally surround a second portion of said first and second driven gears, and wherein said second coupling gear has gear teeth formed at its edge that mesh with said gear teeth on said first transfer gear.

35. The transmission of claim 32 wherein said gearset further includes a second transfer gear surrounding said second output shaft and which has gear teeth meshed with gear teeth on both of said first and second coupling gears, and wherein said transmission further comprising a second coupling unit for selectively limiting rotation of said second transfer gear relative to one of said housing, said second output shaft and said differential cage.

36. The transmission of claim 23 wherein said coupling unit includes a first clutch selectively operable to inhibit relative rotation between said first transfer gear and said housing, and a second clutch selectively operable to inhibit relative rotation between said first transfer gear and said first output shaft.

37. The transmission of claim 23 wherein said coupling mechanism is operable in a first condition to limit relative rotation between said first transfer gear and said housing and in a second condition to limit relative rotation between said first transfer gear and said first output shaft.
